(19) United States
(12) Patent Application Publication
(10) Pub. No.: US 2010/0162390 A1
(43) Pub. Date: Jun. 24, 2010

(54) Automatic proactive means and methods for substantially defeating a password attack

(76) Inventor: Otto Melvin Wildensteiner, Hilton Head, SC (US)

Correspondence Address: Otto M. Wildensteiner, 5 Sanderling Lane, Hilton Head, SC, 29926, US

(21) Appl. No.: 12/314,934

(22) Filed: Dec. 19, 2008

(51) Int. Cl. G06F 11/00; G06F 21/00

(52) U.S. Cl. 726/22

(57) ABSTRACT

Automatic proactive means and methods for substantially defeating a password attack against a computer having a password-protected program installed in it. These means and methods range from not responding at all, to responding with instructions to disrupt the ability of the computer having the attack program in it to continue the attack.

### BACKGROUND

Computer programs that contain sensitive information are usually protected by passwords. In order to use the program, or to access the information in it, a person must supply the password required by that program. These passwords are usually long strings of random alpha-numeric characters; that is, long strings of random letters and numbers. The longer the string, the harder it is to guess it.

However, there are readily available programs (“attack programs”) that can generate a series of random alpha-numeric strings and submit them one at a time to a target program to see which one is the password. Tests have shown that if the attacker continues the attack long enough it is only a matter of time before the attack program generates the correct alpha-numeric string that unlocks the target program.

There are methods of detecting when a password attack is in progress, but so far there are no automatic proactive methods of defeating, or substantially defeating, such an attack by making the password hack-proof.

### OBJECTS OF THE INVENTION

Accordingly, it is an object of the present invention to provide automatic proactive means and methods of making a computer password substantially hack-proof.

It is a further object of the present invention to provide such automatic proactive means and methods that can be implemented in an application program or in the operating system of the computer.

### SUMMARY

Briefly, the present invention comprises means and methods of substantially defeating a password attack. These means and methods are incorporated into the program they are to protect, or can be incorporated into the operating system of the computer on which they reside, thereby protecting all of the programs in the computer. They operate automatically, without the assistance of an operator, as soon as an attack is detected.

### BRIEF DESCRIPTION OF THE DRAWINGS

FIG. 1 shows a flow diagram of one of the proactive means and methods of the present invention, which includes the use of a secondary or decoy computer, incorporated into an application program.

FIG. 2 shows a flow diagram of one of the proactive means and methods of the present invention, which includes the use of a secondary or decoy computer, incorporated into the operating system of a computer.

FIG. 3 shows a flow diagram of one of the proactive means and methods of the present invention which directs the target computer to not respond to the attack.

FIG. 4 shows a flow diagram of one of the proactive means and methods of the present invention wherein a message is sent to the attack computer which disrupts the attack computer's ability to continue the attack.

### DESCRIPTION OF THE PREFERRED EMBODIMENTS

The present means and methods of substantially defeating a password attack require that the attack be detected as soon as possible, either by the program under attack or by the operating system in the computer. Methods for detecting such an attack are well known in the art; however, it is preferred that the method shown in co-pending application Ser. No. ______, filed the same day as the present application, be used to determine that the attack is under way.

When a computer password is under attack, the attack program generates a random alpha-numeric string and sends it to the program under attack. If this is not the correct password, the program under attack (the “target program”) will return an error message such as “invalid password” or “incorrect password”. Sophisticated attack programs are designed to react to such a message by generating and sending another password; in this way the attack programs can generate and send all possible alpha-numeric strings of all lengths in a reasonably short time, depending on the speed of the computers involved.

Each computer on a network, whether the internet or some other network, has a unique address or name. On the internet the address is numerical, such as 174.85.383.59. When a message is sent from a computer, its address is automatically appended to the message; this allows the recipient to send a return message merely by clicking on “reply” or “respond” on the browser's screen without having to manually put the return address on the reply message.

The attack computer looks for this address on the error message sent by the target program and sends the next password to that address.

One of the means and methods of the present invention makes use of a secondary or decoy computer having a different address from the computer being protected. When an attack is detected, the target program automatically puts the return address of this secondary or decoy computer on the first password error message that it sends to the attack computer. The attack program then sends the next password to this secondary or decoy computer. The secondary or decoy computer has only enough software on it to respond to a password that it receives by sending a password error message to the attack computer, which then continues to attack the secondary or decoy computer. This leaves the program able to function normally.

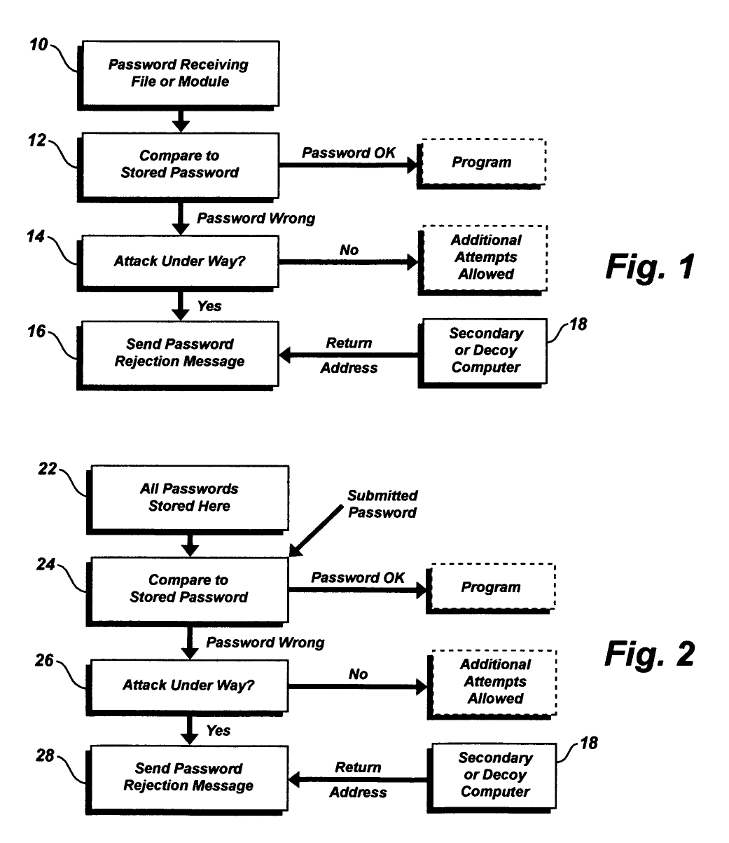

FIG. 1 shows how this method is implemented. The programming routine shown in FIG. 1 is part of a computer program (not shown) that is being protected. Passwords submitted to the program are received in file or module 10 and are then directed to file or module 12 which compares them to the password that is stored in the program. If the submitted password matches the stored password, the sender of the password is allowed access to the program.

If the submitted password does not match the stored password, file or module 14 determines if an attack is underway. This can be done by any means or method, but preferably is done by the means and method shown in co-pending application Ser. No. ______. If an attack is detected, a message is sent to file or module 16 which sends a password-rejection message and attaches the address of secondary or decoy computer 18 as the return address of the message. In this way the computer on which the attack program is located * directs all future passwords to secondary or decoy computer 18 and not the computer on which the program resides. Secondary or decoy computer 18 has just enough software on it to receive and reject all passwords sent to it.

If the submitted password is incorrect but no password attack has been detected in file or module 14, additional attempts at submitting passwords are allowed. File or module 14 allows additional passwords to be received and processed after file or module 18 sends a password error message.

As a result, even if the attack program generates the correct password it will not gain entry into the program since the password will have been sent to secondary or decoy computer 18, which does not contain the program. The attack program will continue to generate and send passwords, since there is nothing in the rejection to indicate to the attack program that the passwords are not being compared to the password stored in the program under attack. Likewise, the person who initiated the attack does not know that the passwords are not being sent to the program under attack; all he knows is that the attack is not succeeding.

The routine of the present invention can be incorporated into a single program or into the operating system of the computer, where it can protect all programs in the computer. In this latter configuration, shown in FIG. 2, all passwords for the programs in the computer are stored in file or module 22. When a password is submitted to an application program the program sends the submitted password to file or module 24 which determines whether or not an attack is under way. If an attack is detected, the routine operates as it does when installed in a single program. That is, file or module 26 within the operating system sends a password rejection message back to the computer that sent it but attaches the return address of the secondary or decoy computer (not shown) on the rejection message, and the attack then proceeds against the secondary or decoy computer as above.

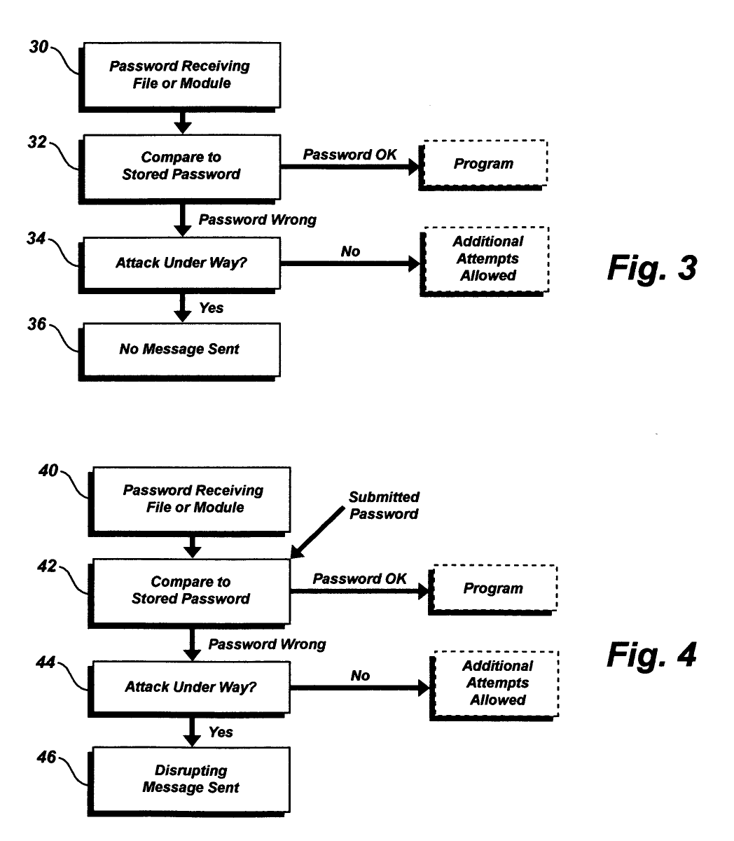

Another proactive means and method of substantially defeating a password attack is to have the program being attacked do nothing when an attack is detected. This is shown in FIG. 3, wherein when a password is received in file or module 30 it is compared in file or module 32 to the stored password. If the submitted password is identical to the stored password, access is granted to the program. If the submitted password is different from the stored password, file or module 34 determines if an attack is underway as shown in co-pending application Ser. No. ______. If no attack is detected, additional attempts at submitting the correct password are allowed. If a password attack is detected, file or module 36 prevents the program from responding with a password error message, thereby stopping the attack since the attack program is designed to respond to a password error message from the program under attack.

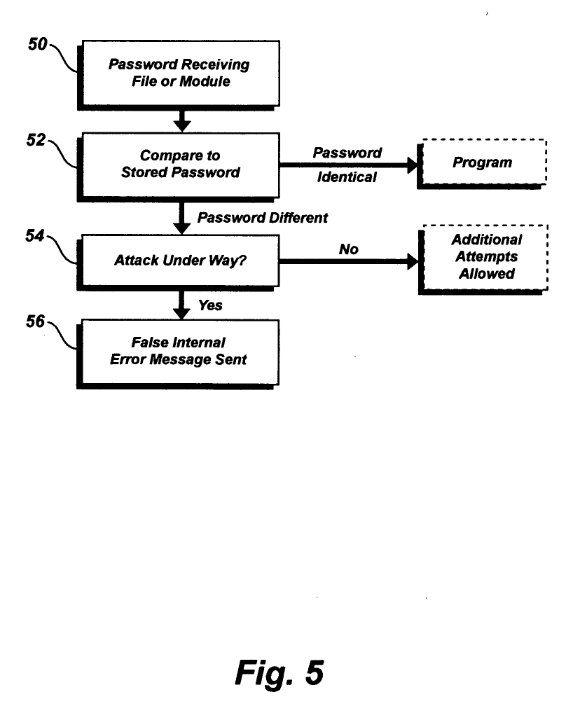

Another proactive means and method of substantially defeating a password attack is to have the target program send a response to the attack computer that includes instructions to reformat the hard drive of the attack computer, delete the attack program, or otherwise disrupt the attack computer's ability to continue the attack. This is shown in FIG. 4, wherein when a password is received in file or module 40 and file or module 42 compares it to the stored password. If file or module 42 determines that the submitted password is identical to the stored password, it grants access to the program. If file or module 42 determines that the submitted password is different from the stored password, file or module 44 determines if a password attack is under way as shown in co-pending application Ser. No. ______. If no attack is determined, additional attempts at submitting the correct password are allowed. If file or module 44 determines that an attack is under way, it directs the program to send a response to the attack program that includes instructions to reformat the hard drive, delete the attack program, or otherwise disrupt the attack program's ability to continue the attack.

Another proactive means and method of substantially defeating a password attack is to have the target program send the attack computer a false message that the program has encountered an internal error and will shut down, and then not respond to any further passwords submitted by the attack program. This is shown in FIG. 5, wherein a password is received in file or module 50 and file or module 52 compares it to the stored password. If the password is identical to the stored password, access is granted to the program. If the password is different from the stored password, file or module 54 determines if an attack is under way as shown in co-pending application Ser. No. ______. If no attack is detected, additional attempts to submit the correct password are allowed. If file or module 54 detects an attack, file or module 56 directs the program to send a false message that the program has encountered an internal error and will shut down, and then directs the program to not respond to any further passwords from the attack computer as shown above.

Obviously these latter 3 means and methods can be incorporated into the individual programs to be protected or they can be incorporated into the operating system of the computer, and thereby protect all of the programs, as shown above for the first means and method. That is, instead of a single password being stored in each application program, all passwords are stored in a file or module in the operating system of the computer. This file or module compares the submitted password with the stored password for the appropriate program, and the proactive defensive means are carried out within the operating system, with the final instructions being sent to the appropriate application program.

I claim:

1. A computer, an operating system within said computer, a password-protected application program within said computer, a secondary or decoy computer, means for detecting an attack on said password, and automatic proactive means within said computer for substantially defeating an attack on said password.

2. A computer as in claim 1 wherein said proactive means is contained in either said application program or said operating system.

3. A computer as in claim 2 wherein said proactive means comprises means for redirecting an outside computer that is attacking said application program to said secondary or decoy computer.

4. A computer as in claim 3 wherein said password-protected application program responds to an attack on its password by attaching the address of said secondary or decoy computer to its password error message instead of its own address.

5. A computer as in claim 1 wherein said secondary or decoy computer contains only enough software to receive and reject all passwords sent to it.

6. A computer having installed within it an operating system, a password-protected application program, means for detecting a password attack, and automatic proactive means for preventing said application program from responding to an incorrect password submitted to it with a “password error” message or any other message.

7. A computer as in claim 6 wherein said means for preventing said application program from responding is contained in said application program.

8. A computer as in claim 7 wherein said means for preventing said application program from responding is contained in said operating system.

9. A computer having installed within it an operating system, a password-protected application program, means for detecting a password attack that is mounted by an outside computer, said outside computer having a hard drive and a password attack program installed in it, and automatic proactive means for responding to a password attack comprising means for sending instructions to said outside computer which is mounting said attack to disrupt said outside computer's ability to continue said attack.

10. A computer as in claim 9 wherein said instructions for disrupting comprise instructions to reformat said hard drive in said outside computer.

11. A computer as in claim 9 wherein said instructions for disrupting comprise instructions to delete said attack program from said outside computer.

12. A computer as in claim 9 wherein said means for disrupting comprises means for sending in response to the initiation of a password attack a false message that said application program has encountered an internal error and will close.
